(19) United States
(12) Patent Application Publication
(10) Pub. No.: US 2007/0117018 A1
(43) Pub. Date: May 24, 2007

(54) SILICON AND/OR BORON-BASED POSITIVE ELECTRODE

(76) Inventor: Robert A. Huggins, Stanford, CA (US)

Correspondence Address: LOUIS WU, P.O. BOX 10074, OAKLAND, CA, 94610, US

(21) Appl. No.: 11/561,542

(22) Filed: Nov. 20, 2006

Related U.S. Application Data
(60) Provisional application No. 60/738,863, filed on Nov. 22, 2005.

(51) Int. Cl. H01M 4/58; C01B 33/00; C01B 33/06

(52) U.S. Cl. 429/231.95; 423/324; 423/344

(57) ABSTRACT

An inorganic electroactive material is provided containing Si and/or B as a microstructural-defining element. The material allows for reversible electrochemical insertion/extraction of Li ions therein/therefrom. In addition, the material may have a high specific reversible capacity and may allow for the substantially reversible electrochemical reaction to be carried out at a high reversible potential versus Li/Li⁺. Also provided is an electrochemical cell using the material in a positive electrode and a method for preparing a positive electrode.

### CROSS REFERENCE TO RELATED APPLICATIONS

This application claims priority to U.S. Provisional Application Ser. No. 60/738,863, entitled “SILICON AND/OR BORON/BASED POSITIVE ELECTRODE,” filed on Nov. 22, 2006, by inventor Robert A. Huggins, the disclosure of which is incorporated by reference in its entirety.

### BACKGROUND

1. Technical Field

The invention relates generally to positive electrodes that include an inorganic electroactive material having Si and/or B as a microstructure-defining element. In particular, the invention relates to such electrodes that allow for reversible electrochemical insertion/extraction of Li ions therein/therefrom.

2. Background Art

Electrochemical cells used in primary and second battery applications may employ different electroactive materials in their electrodes. They are generally inorganic solids. For example, upon discharge, a negative electrode that includes metallic lithium as an electroactive material may be used to supply Li ions into the electrolyte and electrons to the external circuit. In such a case, a positive electrode may include a positive electroactive material having a structure into which Li ions are inserted reversibly from the electrolyte during discharge. Electrons from the external circuit serve to compensate for reduction of the electroactive material in the positive electrode.

In secondary systems, chemical reactions taking place at the electrodes must be reversible. On charge, removal of electrons from the positive electrode releases Li ions back to the electrolyte to restore the structure of the positive electrode's electroactive material parent host structure. Similarly, addition of electrons to the negative electrode attracts charge-compensating Li ions back into the anode.

Li-ion batteries have gained wide commercial because of their superior properties and performance compared to other types of batteries. The lithium battery market, particularly in portable electronic device applications, was a three-billion dollar market in 2003 and is growing at a substantial rate. Proposed future applications for Li-ion batteries include hybrid internal combustion-electrical vehicles. While commercially available hybrid automobiles currently use nickel-metal hydride batteries as a power source, there is significant interest in replacing nickel-metal hydride batteries with Li-ion batteries. Li-ion batteries exhibit a superior weight and volumetric capacity relative to nickel-metal hydride batteries. This is very important for such an application.

Typically, rechargeable Li-ion batteries use a carbonaceous material as a negative electroactive material into which lithium is reversibly inserted. For example the reversible capacity for graphite, a highly-ordered layered form of carbon, is theoretically about one Li atom to six C atoms. Accordingly, the theoretical maximum specific capacity for graphite is about 370 mAh/g.

However, other compositions have been explored for use as negative electroactive material as well. For example, various forms of silicon-based materials have been investigated. In general, silicon-based materials are attractive materials because they not only can provide large capacities, but they are considered unlikely to present any significant safety issues since silicon is neither poisonous nor likely to cause thermal runaway at high temperatures.

It has been shown that amorphous silicon can be formed by the reaction of lithium with crystalline silicon as well as a number of different silicides at high lithium activities, i.e., at low potentials. See e.g., Netz et al. (2003), “The formation and properties of amorphous silicon as negative electrode reactant in lithium systems,” J. Power Sources 95:119-121, and Netz et al. (2004), “Amorphous silicon formed in-situ as negative electrode reactant in lithium cells,” Solid State Ionics, 175:215. In addition, other materials containing silicon have been proposed for use as a negative electroactive material for Li-ion battery applications. For example, U.S. Patent Application Publication No. 20050031957 to Christensen et al. describes a battery having a negative electrode that includes particles of a Si containing electroactive material having an average particle size of 1 μm to 50 μm. Because of the low weight of silicon, this leads to high values of specific capacity. Experimental results have shown that silicon may have a reversible capacity about one Li per Si. Accordingly, the specific capacity for Si may be about 950 mAh/g.

Rechargeable Li-ion batteries typically employ layered or framework transition-metal oxides as a positive electroactive material. Layered Co and/or Ni oxides typically have relatively low specific capacities of about 140 to 160 mAh/g. In addition, such layered oxides are expensive and may degrade due to the incorporation of unwanted species from the electrolyte. While spinal oxides such as LiₓMn₂O₄ have also been proposed for use as positive electroactive materials, manganese spinel oxides typically have a lower specific capacity than layered Co and/or Ni oxides, and their capacities decay significantly, especially at high temperatures.

In any case, known electroactive material components of positive electrodes generally occupy more volume and are heavier than electroactive material components of negative electrodes. Thus, an improvement in the capacity of positive electrode materials is especially important. Even a 10% improvement in capacity would provide a significant commercial and performance advantage.

A number of different approaches have been followed to improve positive electrode performance. In general, the search for positive electroactive materials has focused on transition metal-based compounds that contain one or more chalcogens. For example, as discussed above, lithiated cobalt oxides, nickel oxides and manganese oxides are well known positive electroactive materials. Among the most interesting alternatives at the present time are lithium transition metal phosphides. An example is described in U.S. Patent Application Publication No. 20050244321 to Armand et al. which describes various transition metal-based compounds having an ordered-olivine, a modified olivine, or the rhombohedral NASICON structure and the polyanion (PO₄)³⁻ as at least one constituent for use as electrode material for alkali-ion rechargeable batteries. While phosphorous is disclosed as partially substitutable by silicon, silicon is not a microstructural-defining element of the described transition metal-based compounds. The silicon would be present in polyhedral silicate anions, analogous to the phosphate anions.

In addition, positive electroactive materials sometimes exhibit unacceptable levels of cyclic degradation in capacity. Such cyclic degradation is particularly pronounced at high temperatures. To address this drawback, U.S. Patent Application Publication No. 20050153206 to Oesten et al. describes that positive electroactive material may be coated with one or more layers containing one or more kinds of metallic components, e.g., Si, and one or more components selected from the group consisting of sulfur, selenium, and tellurium. Such a coating is described as being useful for preventing the dissolution of the positive electroactive material that causes cyclic capacity degredation. However, there is no disclosure or suggestion in this published patent application that the coating material itself can be used as a high-capacity electroactive material.

It has been now been discovered that certain inorganic materials having a structure formed from Si and/or B may be advantageously used as electroactive materials in positive electrodes. In particular, such materials which allow for substantially reversible electrochemical insertion/extraction of Li ions therein/therefrom are particularly suited for secondary Li-ion battery applications.

### SUMMARY OF THE INVENTION

In a first embodiment, the invention relates to an inorganic electroactive material containing Si and/or B as a microstructural-defining element. The material allows for reversible electrochemical insertion/extraction of Li ions therein/therefrom and may be used in a positive electrode of an electrochemical cell.

In some instances, the electroactive material allows for substantially reversible electrochemical insertion/extraction of Li ions therein/therefrom to be carried out at a reversible potential versus Li/Li⁺ of at least about 3 volts. In addition or in the alternative, the material may have a specific reversible capacity of at least about 150 mAh/g. In any case, the material is particularly suited for rechargeable Li-ion battery applications.

In another embodiment, the invention relates to an electrochemical cell that exhibits an open circuit potential of at least about 1.5 volts. The cell includes a negative electrode, a positive electrode, and an electrolyte in ionic contact with the electrode. The positive electrode includes the electroactive material as described above.

In another embodiment, the invention relates to a method for preparing a positive electrode. The method involves providing an inorganic electroactive material containing Si and/or B as a microstructural-defining element that allows for electrochemical extraction of first Li ions at a first potential range and second Li ions at a second potential range. First Li ions are electrochemically extracted at the first potential range without extracting the second Li ions from the material. The material is then used in a positive electrode within the second potential range.

### BRIEF DESCRIPTION OF THE DRAWINGS

FIGS. 1A and 1B, collectively referred to as FIG. 1, provide plots of data obtained from galvanostatic cycling of crystalline and amorphous silicon, respectively, prepared in argon at a current density 0.1 mA/cm² between 25 mV and 1.5 V versus Li.

FIGS. 2A and 2B, collectively referred to as FIG. 2, provide plots of data obtained from different experiments involving galvanostatic cycling of SiB₃ prepared in air. FIG. 2A shows galvanostatic cycling of SiB₃ at a current density of 0.1 mA/cm² between 90 mV and 1.5 V. FIG. 2B shows galvanostatic cycling of SiB₃ at a current density of 0.1 mA/cm² between 25 mV and 3.0 V.

FIG. 3 is a reproduction of a published plot that illustrates the “trapped lithium” phenomenon in silicon.

### DETAILED DESCRIPTION OF THE INVENTION

Before describing the present invention in detail, it is to be understood that the invention is not limited to specific electrochemical systems or types of cell components, as such may vary. It is also to be understood that the terminology used herein is for the purpose of describing particular embodiments only, and is not intended to be limiting.

In addition, as used in this specification and the appended claims, the singular article forms “a,” “an,” and “the” include both singular and plural referents unless the context clearly dictates otherwise. Thus, for example, reference to “a potential” includes a single potential as well as a range of potentials, reference to “an element” includes a plurality of elements as well as a single element, reference to “a material” includes a single material as well as a combination of materials, and the like.

In this specification and in the claims that follows, reference will be made to a number of terms that shall be defined to have the following meanings, unless the context in which they are employed clearly indicates otherwise.

The term “electroactive” as used to describe an electrode material of an electrochemical cell indicates that the material provides a major contribution to the redox capacity of the cell. For example, a carbonaceous material is typically used as an electroactive material in negative electrodes of Li-ion batteries. In contrast, current collectors and solid electrolyte interfaces (SEI) associated with an electrode are typically considered electroactive.

The term “microstructural-defining element” as used herein refers to an element that serves a critical role in delineating the overall microstructure of an electroactive material. For example, carbon serves as a microstructural-defining element for graphite. Similarly, both Si and B serve as microstructural-defining elements for SiB₃B. In contrast, dopants and impurities contained in electroactive materials are not generally considered microstructural-defining elements of the materials.

The term “substantially reversible” as used to describe an electrochemical reaction involving the insertion/extraction of an ion from an electrode indicates that all or nearly all ions inserted may be extracted when a reverse current is applied. Typically at least about 95% of a reaction product of a substantially reversible reaction can be reconverted into its original reactants. Preferably, at least about 99% of the reaction product can be reconverted into its original reactants. Optimally, at least about 99.5% of the reaction product can be reconverted. The terms “substantial” and “substantially” are used analogously in other contexts, and involve an analogous definition.

In general, the invention pertains to an electrochemical cell that includes a negative electrode, a positive electrode, and an electrolyte in ionic contact with the electrodes. The positive electrode includes an inorganic electroactive material containing Si and/or B as a microstructural-defining element. In addition, the electroactive material allows for reversible electrochemical insertion/extraction of monovalent ions therein/therefrom.

While the electroactive material may allow for reversible electrochemical insertion/extraction of other alkali ions therein/therefrom, the invention is particularly suited for Li-ion applications. Thus, any of a number of materials may be used as the negative electroactive material. For example, the negative electrode may include metallic Li, a Li alloy, or Li compounds such as a lithiated carbonaceous material or a lithiated nitride such as Li—Co nitride. Typically, the negative electrode includes an electroactive material that allows for substantially reversible insertion of at least some of the Li ions. The negative electroactive material may be entirely crystalline, partially amorphous, or entirely amorphous. When the material is crystalline, a layered or framework microstructure ay be present. In any case, a number of different forms of carbon may be used as a negative electroactive material. Exemplary forms for carbon suitable for use with the invention include, graphite, mesophase carbon, amorphous carbon, and fullerenes (spherical and tubular).

The positive electroactive material may be entirely crystalline, partially amorphous, or entirely amorphous as well. When the positive inorganic electroactive material contains Si, the material may take any of a number of different compositions. For example, the positive electroactive material may consist essentially of Si containing Li. Alternatively, a Si alloy containing Li may be provided. Exemplary Si alloys may contain Mg, Ca, B, C, N, Al, Co, Fe, Ni, Mn, Cr, Mo, Ti, V, Cu, and/or Zn. Furthermore, Si compounds may be advantageously used. An exemplary Si compound suitable for the invention is represented by LiₓSi_{y}O_{z}, where 0<x<(y+z) and 0<z<2y. Similarly, when the positive inorganic electroactive material contains boron, the material may be a B alloy or compound.

Alloys of Si and B may be advantageously used in a number of situations. For example, LiₓSi_{y}B_{z}, where 0<x<5y and 0<z<6y, represents an alloy that may exhibit desired charge/discharge performance. Similarly, LiₓSiB₃, where 0<x<5, may exhibit exceptional insertion/extraction characteristics.

As discussed above, the invention is well suited for Li-ion applications, e.g., battery applications Thus, a plurality of the above-described cells may be electrically connected to each other in series or in parallel to form a battery. In order to provide batteries with high energy densities, each cell should exhibit a high energy density. Since energy density of a cell is proportional to its potential, cells having a high energy density may have a high open circuit potential. Thus, the invention may provide cells that exhibit an open circuit potential of at least about 1.5 volts. In some instances, the open circuit potential may exceed about 2.5 to 3 volts. Extremely high open circuit potentials exceeding about 3.5 to about 4.0 or about 5.0 volts may be possible.

Nevertheless, it is sometime difficult to find an electrolyte that is stable over a wide range of potentials. With an inadequately stable electrolyte, performance of cells may degrade to an unacceptable level over time. One of ordinary skill in the art will recognize that there are at least two approaches to solving this problem. One approach involves selecting appropriate electroactive materials so as to ensure that the difference in the materials' electrochemical potentials does not exceed the stability window of the electrolyte. Thus, the above-described voltages may represent upper open circuit potential limits in some instances. Another approach is to select appropriate materials so that a protective SEI (solid electrolyte interface) is formed. Additional approaches may be found upon routine experimentation by those of ordinary skill in the art.

One of ordinary skill in the art will also recognize that the energy density of a cell is proportional to its capacity. Thus, the invention may provide positive electroactive materials that exhibit a high specific reversible capacity. For example, the invention may provide for a specific reversible capacity of more than 150 mAh/g. In some instances a specific reversible capacity of at least about 200 to about 300 mAh/g may be achievable. According to some calculations, as discussed below, a specific capacity of up to about 760 to about 950 or about 1200 mAh/g may be achievable.

It should be noted that Si-based materials have been extensively studied by numerous investigators to evaluate the materials' suitability in negative electrodes. The present invention arose from such experiments involving various silicon- and boron-based materials such as those set forth in Table 1. In order to evaluate these Si-based materials for use in a negative electrode as a host for Li ions, the Si-based materials were each reacted with Li to effect Li insertion therein and cycled.

TABLE 1
Specific Capacity Data for Several Materials Showing
Difference Between Lithium Inserted and Extracted

| | Initial Lithiation | Delithiation |
|---|---|---|
| Material | Capacity mAh/g | Capacity mAh/g |
| FeSi₂ | 81 | 60 |
| CoSi₂ | 96 | 58 |
| NiSi₂ | 327 | 198 |
| CaSi₂ | 510 | 320 |
| SiB₃ | 2215 | 288 |
| Crystalline Silicon | 3230 | 413 |

From the cycling data set forth in Table 1, it is apparent that significantly more lithium reacts with these silicon and boron-containing materials upon the first lithiation than is removed during subsequent cycling at relatively low potentials. In other words, only some of the originally inserted Li was extracted. Accordingly, the remaining inserted Li appeared “trapped” in the host material.

This phenomenon has been generally considered to be an artifact related to an irreversible reaction. There appear to have been no publications describing the cause of the difference between the capacity of the first lithiation and that obtained in later cycles. It is unlikely that such a large loss of capacity is due to the formation of an SEI (solid electrolyte interface) or to the formation of a lithium silicon oxide from reaction with a surface oxide on the Si-based material.

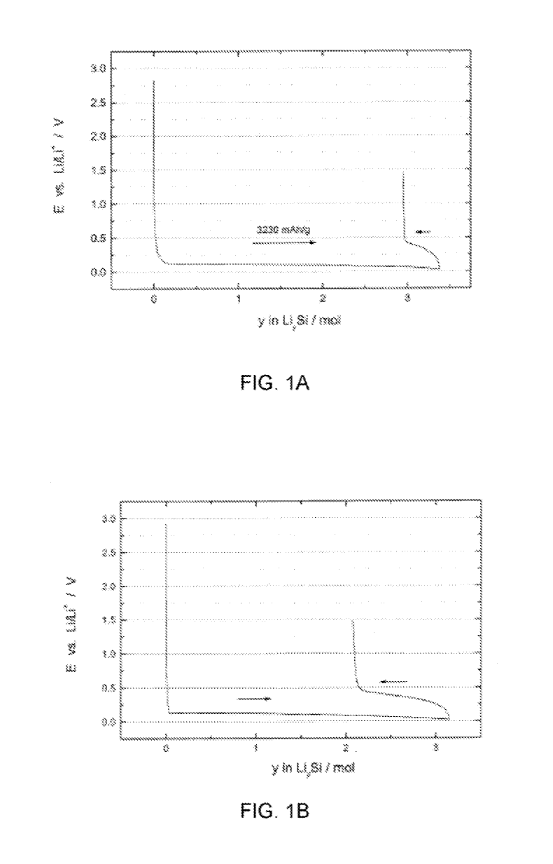

To illustrate the “trapped lithium” phenomenon, the results of several experiments are given below. FIG. 1 shows data from experiments that involved galvanostatic cycling of silicon at a current density 0.1 mA/cm² between 25 mV and 1.5 V versus Li. FIG. 1A shows data from an experiment performed on a sample of crystalline silicon that had been prepared in argon. FIG. 1B shows data from an experiment performed on a sample of silicon that initially was partly amorphous, and partly crystalline and that had also been prepared in argon. These experiments shows that Si, regardless of its crystallinity, may trap a large amount of non-extractible lithium.

Similarly, test cells for each type of silicon were prepared in air. While there are some apparent differences between the data for cells that were assembled in air and for cells that were assembled in an argon glove box, the atmosphere in which the test cells were assembled does not appear to be a significant cause of lithium trapping in these experiments.

It has now been discovered, however, that the trapped lithium may become electrochemically active, i.e., be reversibly extracted and re-inserted, at a high potential versus Li/Li⁺. For example, the “trapped” lithium can be reversibly extracted between about 3 volts about 4 volts versus Li/Li⁺. Such an extraction potential is comparable to the potential range for known positive electroactive materials for Li-ion batteries, rendering the material suitable for use in the positive electrode of Li-ion batteries as well. In other words, the low potentials during the original insertion of lithium are in the range generally considered for negative electrodes, whereas the high potentials related to the extraction and re-insertion of the “trapped” lithium are in the potential range generally considered for positive electrodes.

While not wishing to be bound any particular theory, it should be noted that a number of other materials are known to show electrochemical activity at two (or more) different electrical potentials. These include alloys of interest as battery anode electrode materials, and also some cathode materials. Electrochemical activity at two different potentials, or gas pressures, has also been found in metal hydride systems, in which hydrogen is reversibly absorbed and emitted as either the electrical potential or the temperature is varied.

It is believed that such dual potential behavior has been overlooked in Si because investigations of anode materials generally only go up to 1 to 1.5 V. Such investigations do not involve making measurements up to potentials required to evaluate positive electroactive materials, e.g., above 1.5 to 3 volts versus Li/Li⁺ and preferentially 4 to 5 volts versus Li/Li⁺.

The invention also provides a method for preparing a positive electrode. The method involves providing an inorganic electroactive material containing Si and/or B as a microstructure-defining element that allows for electrochemical extraction of first Li ions at a first (lower) potential range and second Li ions at a second (higher) potential range. Typically, the potential ranges differ from each other by at least about 1 volt. In any case, the first Li ions are electrochemically extracted at the first potential range without extracting the second Li ions. As a result, the material may be used in a positive electrode within the second potential range. Of course, care must be taken when removing lithium from a material, amorphous or otherwise, at high potentials so as to avoid causing irreversible changes in its structure that negatively influence its behavior. This is somewhat analogous to low potential behavior. For example, when lithium reacts with crystalline silicon or certain crystalline silicon-based materials (e.g. silicon alloys) at low electrical potentials, the lithium inserted into the crystal structure may cause the crystalline material to become amorphous.

There are a number of ways in which the above-described inorganic electroactive material may be initially provided. As alluded to above, the material may be formed by electrochemically inserting Li into a host material containing Si and/or B. As an additional example, electrochemical insertion of Li may be carried out by placing Li in contact with the host material in the presence of an electrolyte. More sophisticated methods may be used as well. However, the electroactive material may also be formed by nonelectrochemical techniques. For example, desired proportions (stoichiometric or otherwise) of Li, B, and/or Si-containing precursors may be mixed and heated to produce the above-described electroactive material without the need for electrochemical lithiation.

This method is compatible with known battery assembly techniques for Li-ion technologies. In general, lithium ion cells are currently assembled in the discharged state. In this state, the positive electrode (cathode) contains lithium, and the negative electrode (anode) contains no, or relatively little, lithium. When the cell is charged, some or all of the lithium leaves the positive electrode and enters, or moves through, the electrolyte to the negative electrode (anode). As a result, the amount of lithium within the negative electrode increases as the cell is charged. During discharge, lithium moves from the anode to the cathode.

As lithium is deleted from the cathode, the electrical potential of the cathode is raised. Also, as lithium is added to anode, the electrical potential of the anode is lowered. Thus, the difference in the electrical potentials of the anode and cathode is greatest when the cell is fully charged, and least when the cell is fully discharged.

One advantage of the assembly of the cell in the discharge state is that the active materials in both the anode (now typically a form of carbon) and cathode (now typically a lithium transition metal oxide; e.g., a compound of lithium, another metal such as cobalt, and oxygen) are both generally stable in air. This is in stark contrast to past practices in which lithium batteries were often assembled in the charged state. In the past, it was required that highly reactive materials, such as metallic lithium, be handled in dry and/or low oxygen environments.

To provide some context to the capacity advantages associated with the invention, it should be noted that ordinary positive electroactive materials known in the art have a relatively low specific capacity. This is primarily due to their molar weights. Table 2 shows the influence of the molar weight of a few positive electrode materials on the specific capacity, assuming reaction with the same amount of lithium. The baseline material, LiCoO₂, only reacts with about 0.4 Li per mole. It can be seen that even the reaction with a relatively small amount of reversible lithium with silicon at useful positive electrode potentials could lead to attractive values of specific capacity.

TABLE 2

| | Molar | Relative |
|---|---|---|
| Material | weight | specific capacity |
| LiCoO₂ | 97.87 | 1 |
| LiVPO₄F | 171.19 | 0.57 |
| LiFePO₄ | 157.76 | 0.62 |
| Li—Si | 35.04 | 2.79 |

Thus, one would only need to be able to reversibly extract 0.14 Li per Si at a useful potential for silicon to be competitive on this basis. Stated another way, if one could extract 1 Li per Si (this is about the amount of trapped Li), the specific capacity would be 767 mAh/g. That would be a major step forward, compared to the current values of about 140 to 160 mAh/g.

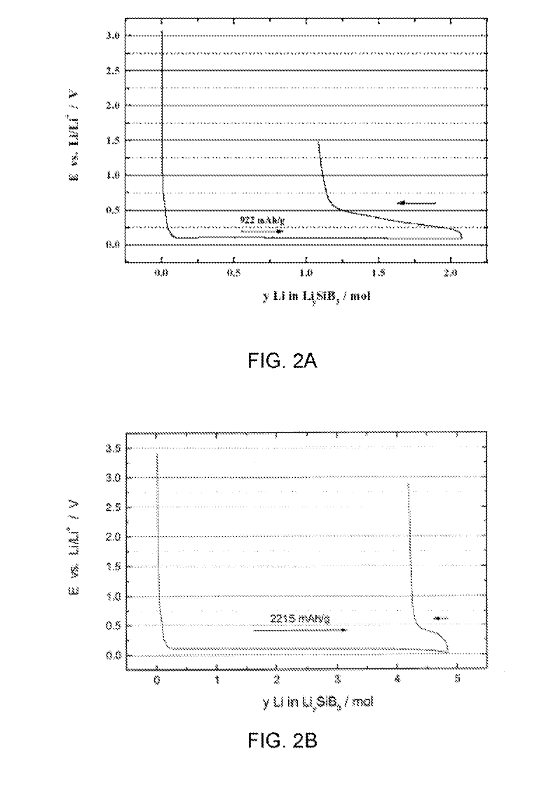

Alloying of the silicon or silicon-containing materials by the addition of other elements may be useful in influencing the amount of “trapped lithium” or the potential at which it becomes electrochemically active. For example, experiments were performed on a material labeled “SiB₃” purchased from several sources. The results of the experiments are shown in FIG. 2. FIG. 2A shows galvanostatic cycling of SiB₃ at a current density of 0.1 mA/cm² between 90 mV and 1.5 V. FIG. 2B shows galvanostatic cycling of SiB₃ at a current density of 0.1 mA/cm² between 25 mV and 3.0 V. Both experiments involved samples that were prepared in air rather than argon. These experiments show that more than 4 mols of Li were initially reacted per mol of “SiB₃,” yet only about 1 mol of Li could be extracted at low potentials. This is an unexpected finding that may be advantageously exploited.

Experiments have been carried out to look for a higher potential reaction of the “trapped lithium” in Si and alloys of Si and B using electrodes made from these materials and a molybdenum current collector. Both show some reaction at about 4 volts. Notably, the data for the silicon-boron alloy suggests a possible specific capacity of over 1,200 mAh/g.

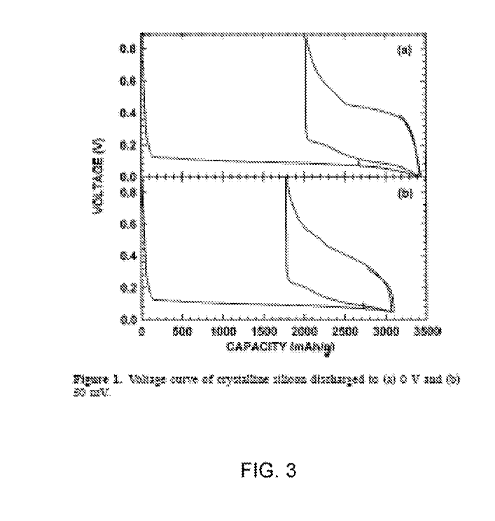

This “trapped lithium” phenomenon has also been observed in Obrovac et al. (2004). “Structural Changes in Silicon Anode during Lithium Insertion/Extraction,” Electrochem. Solid State Letters, 7:A93. FIG. 3 is a reproduction of an Obrovac plot illustrating the trapped lithium phenomenon. As shown in FIG. 3, more than twice as much lithium reacted with (was put into) the silicon as was extracted when the current was reversed.

Variations of the present invention will be apparent to those of ordinary skill in the art in view of the disclosure contained herein. A number of organic electrolytes are known in the art. Such electrolytes are aprotic in nature and, as discussed above, may be selected according to their compatibility with the electroactive materials as well as their electrochemical stability within a particular potential range. It is within the skill of the ordinary artisan to select an appropriate electrolyte, taking into account the electrolyte's viscosity, polarity, ability to solvate particular salts, etc. so as to optimize the performance of the present invention in terms of reversibility, capacity, current capability, storage, etc.

In addition, one of ordinary skill in the art may engage in routine experimentation to optimize materials containing boron, because of its light weight. There is evidence in the literature of the formation of two different lithium-boron phases by direct reaction of the elements at elevated temperatures. It may be possible to form one, or both, at lower temperatures by the use of electrochemical or other methods. Different Si and B alloys may all be nominally labeled “SiB₃,” even though they differ in actual composition, microstructure, and/or crystal structure. In some instances, such alloys may include SiB₄ and/or SiB₆.

It is to be understood that, while the invention has been described in conjunction with the preferred specific embodiments thereof, the foregoing description merely illustrates and does not limit the scope of the invention. Numerous alternatives and equivalents exist which do not depart from the invention set forth above. In general, any particular embodiment of the invention may be modified to include or exclude features of other embodiments. Thus, for example, while the above discussion has focused on silicon-based or boron-based positive electroactive materials, the presence of silicon and/or boron may not be critical. Other elements may be substituted for Si. In addition, while the invention has been discussed in the context of Li-ion electrochemical cells, the presence of Li may not be necessary. In some instances, lithium may be substituted with an alternative monovalent elemental ion, e.g., other alkali ions. Other aspects, advantages, and modifications within the scope of the invention will be apparent to those skilled in the art to which the invention pertains.

All patents, patent applications, and publications mentioned herein are hereby incorporated by reference in their entireties.

I claim:

1. An electrochemical cell, comprising:
a negative electrode;
a positive electrode comprising an inorganic electroactive material containing at least Si and/or B as a microstructural-defining element and that allows for reversible electrochemical insertion/extraction of Li ions therein/therefrom; and
an electrolyte in ionic contact with the electrodes,
wherein the cell exhibits an open circuit potential difference between the electrodes of at least about 1.5 volts.

2. The cell of claim 1, wherein the positive inorganic electroactive material contains Si.

3. The cell of claim 2, wherein the positive inorganic electroactive material consists essentially of Si containing Li.

4. The cell of claim 2, wherein the positive inorganic electroactive material is a Si alloy containing Li.

5. The cell of claim 4, wherein the Si alloy contains Mg, Ca. B, C, N, Al, Co, Fe, Ni, Mn, Cr, Mo, Ti, V, Cu, or Zn.

6. The cell of claim 5, wherein the Si alloy is LiₓSi_{y}B_{z}, where 0<x<5y and 0<z<6y.

7. The cell of claim 6, wherein the Si alloy is LiₓSiB₃, wherein 0<x<5.

8. The cell of claim 2, wherein the positive inorganic electroactive material is LiₓSi_{y}O_{z}, where 0<x<(y+z) and 0<z<2y.

9. The cell of claim 1, wherein the positive inorganic electroactive material contains B.

10. The cell of claim 9, wherein the positive inorganic electroactive material is a B alloy.

11. The cell of claim 9, wherein the positive inorganic electroactive material is a B compound.

12. The cell of claim 1, wherein the positive inorganic electroactive material is at least partially amorphous.

13. The cell of claim 12, wherein the positive inorganic electroactive material is entirely crystalline.

14. The cell of claim 1, wherein the positive inorganic electroactive material is entirely crystalline.

15. A rechargeable battery comprising a plurality of cells of claim 1 electrically connected to each other.

16. An inorganic electroactive material containing at least Si and/or B as a microstructural-defining element and that allows for substantially reversible electrochemical insertion/extraction of Li ions therein/therefrom at a reversible potential versus Li/Li⁺ of at least about 1.5 volts and/or at a specific reversible capacity of at least about 100 mAh/g.

17. The material of claim 16, wherein the material allows for substantially reversible electrochemical insertion/extraction of Li ions therein/therefrom at a reversible potential versus Li/Li⁺ of at least about 1.5 volts.

18. The material of claim 16, wherein the materal allows for substantially reversible electrochemical insertion/extraction of Li ions therein/therefrom at a specific reversible capacity of at least about 100 mAh/g.

19. A method for preparing a positive electrode, comprising:
(a) providing an inorganic electroactive material containing at least Si and/or B as a microstructural-defining element and that allows for electrochemical insertion and extraction of first Li ions at a first potential range and second Li ions at a second potential range;
(b) electrochemically extracting the first Li ions at the first potential range without extracting the second Li ions from the material; and
(c) using the material in a positive electrode within the second potential range.

20. The method of claim 19, wherein the potential ranges differ from each other by at least about 1 volt.
